(19) United States
(12) Patent Application Publication
(10) Pub. No.: US 2005/0138076 A1
(43) Pub. Date: Jun. 23, 2005

(54) Description and implementation method of threadbean in EJB container

(76) Inventors: Beom Su Seo, Taejon (KR); Sung Hoon Kim, Taejon (KR); Seung Wook Jung, Taejon (KR); Kyeong Ho Lee, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/837,600

(22) Filed: May 4, 2004

(30) Foreign Application Priority Data
Dec. 19, 2003 (KR) 2003-94077

(51) Int. Cl. G06F 17/30

(52) U.S. Cl. 707/104.1

(57) ABSTRACT

The present invention relates to a description and implementation method of ThreadBean in an Enterprise Java Bean (EJB) container. In the description and implementation method of ThreadBean in an EJB (Enterprise Java Bean) container, the ThreadBean is defined using EJB to which an independent thread is allocated such that looping is performed while a message entering a determined message target is processed or a business logic periodically driven to perform a specific work is processed.

### BACKGROUND OF THE INVENITON

1. Field of the Invention

The present invention relates to a description and implementation method of ThreadBean in an Enterprise Java Bean (EJB) container, and more particularly, to a description and implementation method of ThreadBean in an EJB container for supporting when a business application is developed using a thread in EJB.

2. Description of the Related Art

A conventional EJB is comprised of an Entity Bean, a Session Bean and a Message Driven Bean. However, since the conventional EJB is prohibited from internally generating and using a new thread, a business application performing the following work cannot be achieved using the EJB in the specification if an expedient is not employed.

As the business application, there are a business application for processing data entering while monitoring a port of a specific socket, a business application for processing e-mail entering while monitoring a specific mail account, a business application for processing a message entering while monitoring a specific instance message, a business application periodically driven to backup a file or prepare statistics, and the like.

In the meanwhile, data entering a Topic or a Queue of a Java Message Service can be processed as the Message Driven Bean in EJB 2.0. However, the Message Driven Bean is also the same as other Beans and is internally processed by Message Bean container irrespective of the thread. That is, in case that a developer needs to intentionally use the thread, there is no method for supporting it. Further, only a message of the Java Message Service can be asynchronously processed.

In EJB 2.1, the EJB 2.0 is more extended and flexibility is provided for a thread use. According to EJB 2.1, if enterprises that provide database, ERP, mail, Java Message Service and the like, wants to integrate their products within an application server, they are forced to implement and provide a resource adapter using a proposed method of an EJB 2.1 specification. This is the same as in the EJB 2.0, but the EJB 2.0 limits a resource by the Java Message Service so as to process an asynchronous message while as it is allowed to asynchronously process various types of message in the EJB 2.1 At this time, a method for monitoring a specific message destination is required. For this, the EJB 2.1 employs a way where a resource vendor provides the resource adapter together with the resource while requesting a monitoring work for the message destination to the application server.

The resource adapter submits an object, that is called “Work”, to the application server, and the application server allocates a available thread to drive the work object instead of the resource adapter, thereby performing the monitoring work. In this method, since the resource adapter does not exist if the resource does not exist, the object to be monitored does not exist. That is, the application server thoroughly allocates and drives the thread for the work submitted by the resource. Since an interface proposed for this is also different from an EJB interface, the thread is generated and managed in an entirely different way. Resultantly, when the developer intends to drive the thread to perform a specific work according to need of the business application, there is no proper method to implement this in the same way as conventional EJB under current EJB specification.

### SUMMARY OF THE INVENTION

Accordingly, the present invention is directed to a description and implementation method of ThreadBean in an EJB container, which substantially obviates one or more problems due to limitations and disadvantages of the related art.

It is an object of the present invention to provide a description and implementation method of ThreadBean in an EJB container in which a new EJB called “ThreadBean” is provided such that an application, where a developer uses the thread, can be developed and driven in the same way as a conventional EJB.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a description and implementation method of ThreadBean in an EJB (Enterprise Java Bean) container, wherein the ThreadBean is defined using EJB to which independent thread is allocated such that looping is performed while a message entering a determined message target is processed or a business logic periodically driven to perform a specific work is processed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a view illustrating an example of an interface having ThreadBean and ThreadContext defined according to a preferred embodiment of the present invention;

FIG. 2 is a view illustrating an example of an implement code of ThreadBean according to a preferred embodiment of the present invention;

FIG. 3 is a view illustrating an example of a deployment descriptor which should be provided together with ThreadBean according to a preferred embodiment of the present invention;

FIG. 4 is a view illustrating an example of a MessageListenerImpl code for a Java Message Service according to a preferred embodiment of the present invention;

FIG. 5 is a view illustrating a procedure where a ListenerImpl code is created adaptively to a type of a listener defined by a deploy tool at a deployment descriptor after ThreadBean is prepared according to a preferred embodiment of the present invention;

FIG. 6 is a view illustrating a procedure of creating ThreadBean container and driving ThreadBean according to a preferred embodiment of the present invention;

FIG. 7 is a view illustrating an exemplary procedure of preparing to receive a message from a message target monitoring after ThreadBean is driven according to a preferred embodiment of the present invention;

FIG. 8 is a view illustrating an exemplary procedure where a message is transmitted and processed to and in a message process function of a corresponding ThreadBean via ThreadBeanContainer after the message is received according to a preferred embodiment of the present invention; and

FIG. 9 is a view illustrating an exemplary procedure where used ThreadBean and allocated thread are put in a pool after ThreadBean is ended according to a preferred embodiment of the present invention.

### DETAILED DESCRIPTION OF THE INVENTION

Reference will now be made in detail to the preferred embodiments of the present invention, examples of which are illustrated in the accompanying drawings.

In order to achieve a technical subject, the present invention defines an interface for ThreadBean.

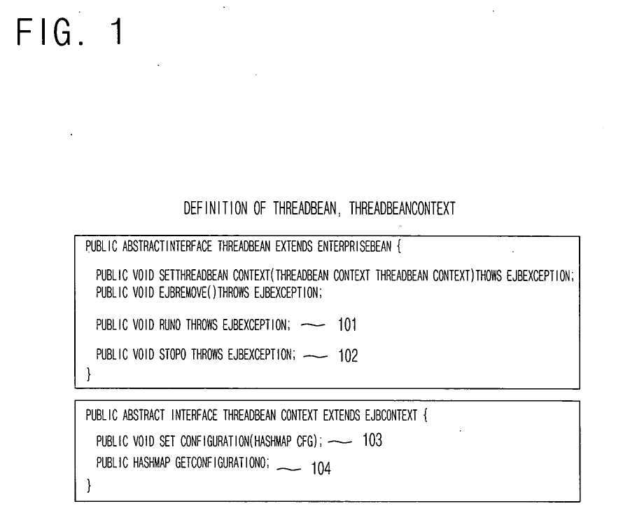

FIG. 1 is an interface definition for ThreadBean and ThreadBeanContext.

Its java package is javax.ejb identical with a conventional EJB package. The ThreadBean inherits all methods of EnterpriseBean, and additionally defines run( ) 101 and stop( ) 102. In the run( ), a work which a Bean developer intends to do using thread (that is, a work performed looping or monitoring for a specific port) is programmed. In the stop( ), the developer performs a necessary work so as to stop the ThreadBean. The ThreadBeanContext contains information necessary for execution of the ThreadBean, and inherits methods of EJBContext. Information necessary for the execuion of the ThreadBean is variously defined in a deployment descriptor.

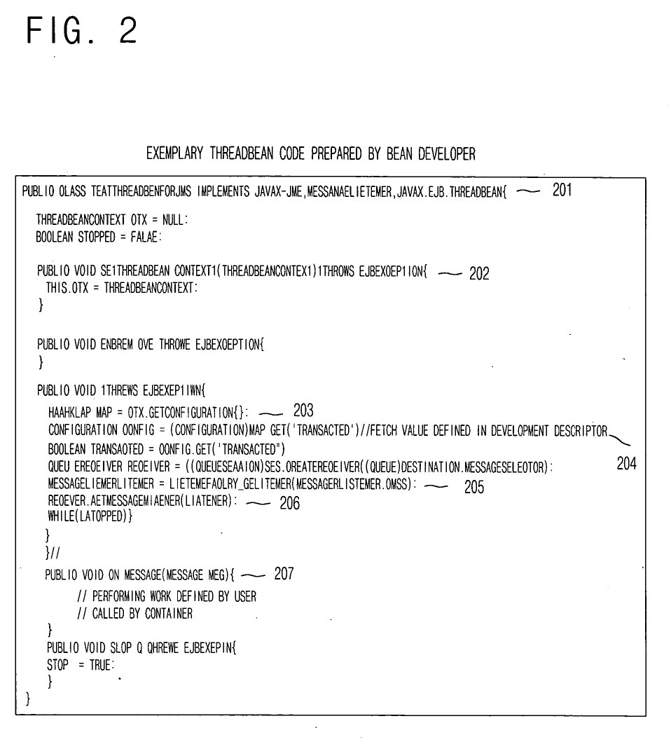

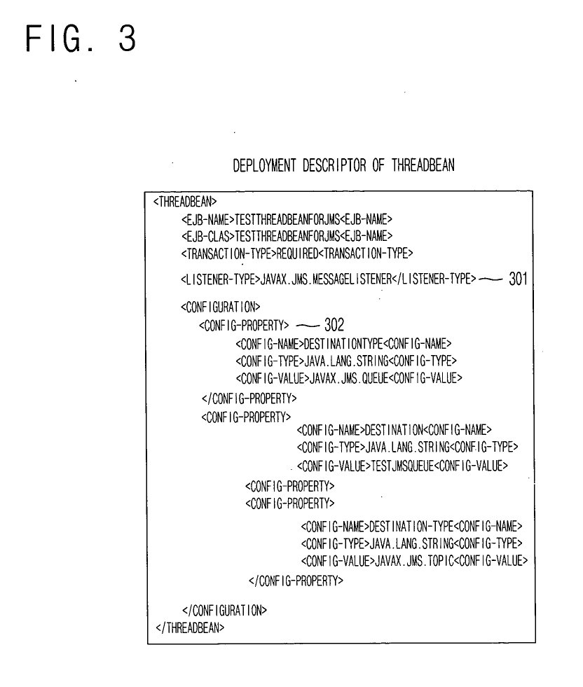

FIG. 3 is a view illustrating the deployment descriptor. The deployment descriptor additionally includes a tag 301 for designating a type of an object monitoring a message destination together with a common tag defined in a specification, and a set information tag 302 for transmitting set information necessary for driving the ThreadBean. The ThreadBeanContext is used to transmit information, which is defined in the deployment descriptor, to the ThreadBean at an execution time. Reference numerals 103 and 104 of FIG. 1 represent the interface where ThreadBeanContainer creates the ThreadBean while receiving the deployment descriptor of FIG. 3 such that desired values are set as a hash map data structure to be transmitted to the ThreadBean, and are used such as 202 of FIG. 2.

FIG. 2 illustrates a simple example of the ThreadBean. A real ThreadBean uses set information such as 203 and 204 of FIG. 2. Herein, a Configuration object contains the set information specified in the deployment descriptor, and has a name, a value and a type of the set information. The developer should define a listener interface 201 adaptively to a message type and implement it in the ThreadBean such that the ThreadBean can monitor the message destination or perform a periodical work. In case of the ThreadBean performing the periodical work without monitoring the message destination, the listener interface is the interface defining the method performing the periodical work. In the present invention, the above interface is also commonly called “listener interface” for understanding convenience.

The reference numeral 203 of FIG. 2 represents the method existing at javax.jms.MessageListener and is implemented by the developer. ThreadBean container executes a run( ) method of the ThreadBean through an independent thread. If the message is transmitted, the container receives the transmitted message to allow a desired work to be performed through the method 203 finally defined by the developer. The reason why the container participates in the message reception is that the container performs a function such as a security check, a transaction check or the like in the same manner as in other EJBs, and then allows the ThreadBean to execute the work finally programmed by the developer.

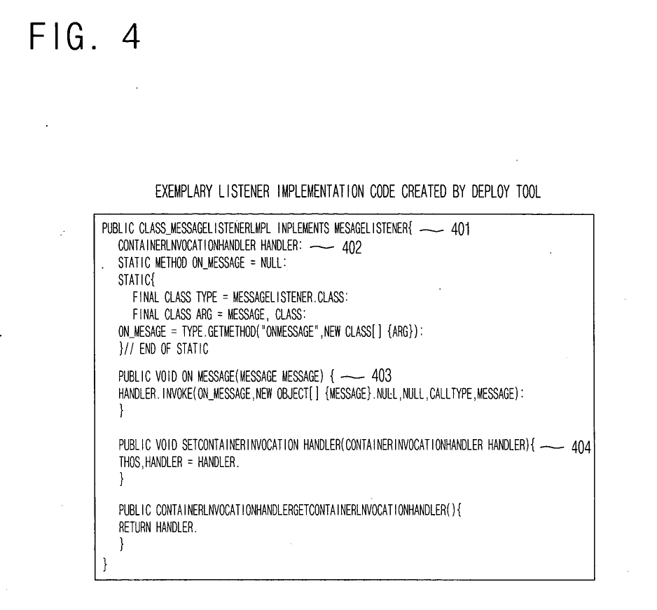

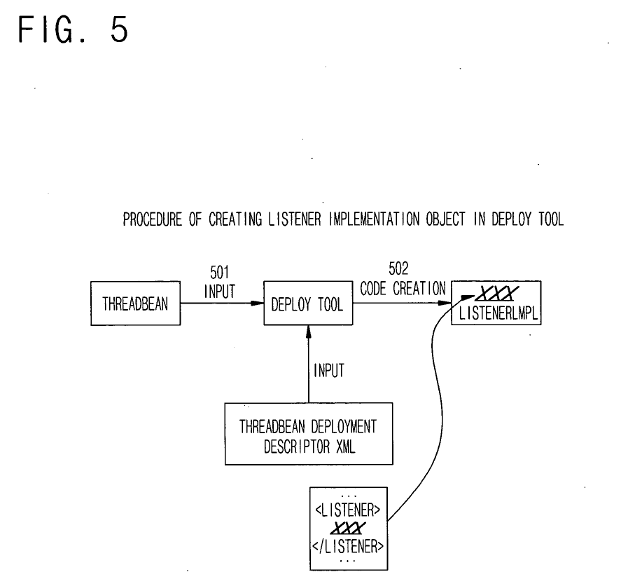

In order to allow the Container(→container) to participate in the message transmission, a deploy tool uses a ThreadBean deployment descriptor (FIG. 3) and the ThreadBean (FIG. 2) provided by the developer to create a listener implementation code used by the container. FIG. 5 illustrates the above procedure, and FIG. 4 illustrates an example of the listener implementation code created by the deploy tool.

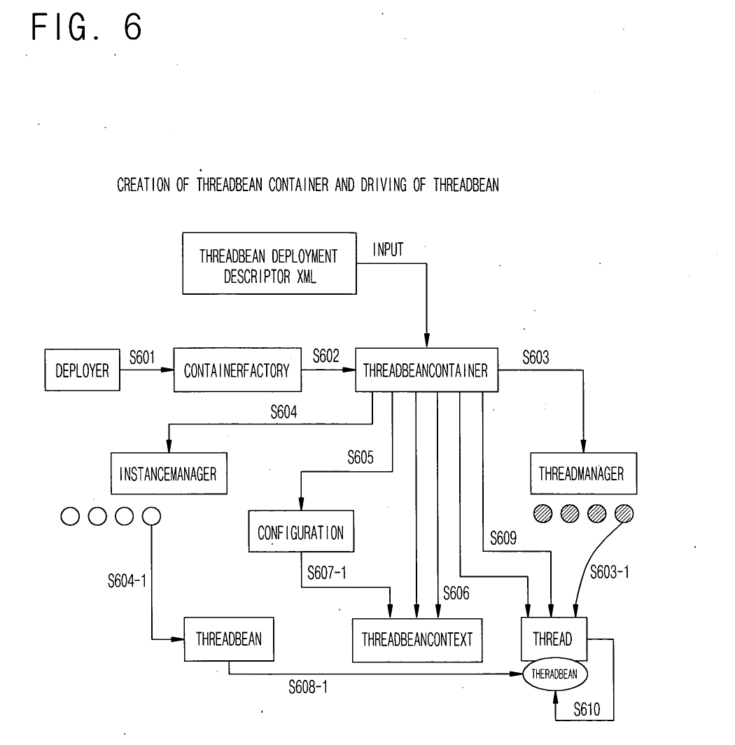

FIG. 6 illustrates a procedure of creating the ThreadBean container and then driving the ThreadBean.

In step 601, a deployer deploys the ThreadBean.

In step 602, ContainerFactory for creating Entity, Session, Message Driven and ThreadBean container creates the ThreadBeanContainer. At this time, a deployment descriptor defined in XML is provided together.

In step 603, the created ThreadBeanContainer requests one available thread to ThreadManager existing at an application server. The ThreadManager returns the thread previously pooled or, creates and returns a new thread if the pooled thread does not exist (603-1).

In step 604, the ThreadBeanContainer requests instance of the ThreadBean to InstanceManager (a management object for managing a life cycle of each EJB instance and providing a function of cache, pooling and the like) existing at the application server. The InstanceManager previously creates and pools a predetermined number of the ThreadBean, or creates and returns if the previously pooled ThreadBean does not exist (604-1).

In step 605, a variety of information necessary for the ThreadBean execution is obtained from the ThreadBean deployment descriptor inputted in the step 602 and then, a Configuration object containing the variety of information is created. As mentioned above, the Configuration object is a Java Bean object for storing the values specified in the tag 302 of FIG. 3, and setting and returning the name, the type and the value.

In step 606, ThreadBeanContext object is created to store a ThreadBean execution environment.

In step 607, the Configuration object created in the step 605 is set to the ThreadContext (607-1).

In step 608, the ThreadBean is allocated to the thread newly obtained from the ThreadManager in the step 603 (608-1).

In step 609, the run( ) method of the thread is called.

In step 610, the thread object requested for the run( ) requests an execution of the run( ) method to the ThreadBean object selected in the step 604.

The run( ) method of the ThreadBean deployed by the developer through the above procedure is called by the thread allocated by the application server to wait the message or be periodically driven, thereby performing the work. When the developer prepares the business application, which should perform the work through the thread, the developer freely, describes a desired application in the run( ) method and, uses the execution environments needed at this time through the ThreadBean Context. That is, the developer can be supported identically with other EJBs by a middleware function such as thread, transaction and security provided by the application server, while defining and managing the ThreadBean irrespective of an actual performed work (not needing to know whether what type of message is or what information is needed) such that what type of services can be freely plugged. In the EJB 2.0, when the Message Driven Bean is defined, a necessary execution environment is defined in the deployment descriptor using an explicit tag not a Configuration type and the container also explicitly uses the tag, thereby causing extensibility to be reduced.

After the ThreadBean is actually driven through the run( ), in the run( ), the listener object for the destination monitored by the ThreadBean should be allocated from the container through a procedure of such as 205 of FIG. 2. For this work, ListenerFactory is proposed. The ListenerFactory performs a role of generating and returning the object of a listener implementation class generated by the deploy tool as another object which should be provided by the container so as to provide the ThreadBean.

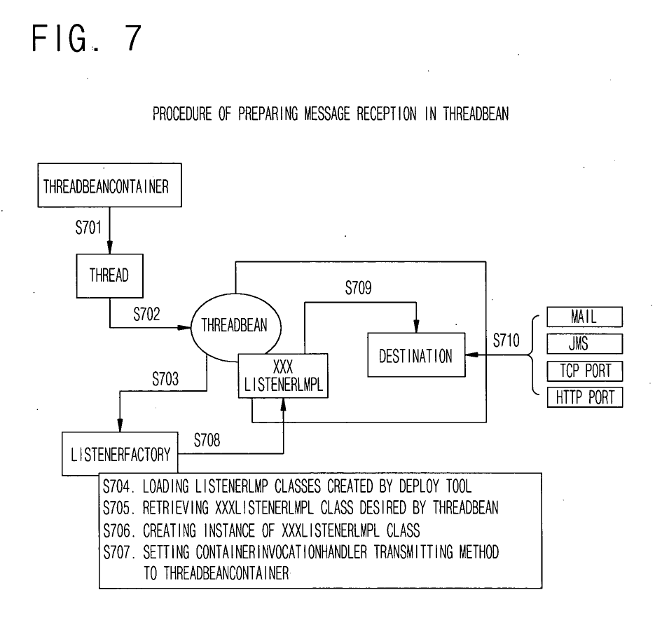

FIG. 7 illustrates a procedure of an execution of the run( ) method and a reception preparation of the message in the ThreadBean.

In step 701, the ThreadBeanContainer calls the run( ) for the thread allocated in the step 603 of FIG. 6.

In step 702, the allocated thread calls the run( ) of the ThreadBean.

In step 703, the Listener implementation code is requested to the ListenerFactory as in the step 205 of FIG. 2.

In step 704, the ListenerFactory loads the listener implementation classes generated by the deploy into a memory.

In step 705, the listener implementation class desirably requested by the ThreadBean is retrieved among the loaded classes.

In step 706, the instance of the retrieved listener implementation class is generated.

In step 707, ContainerInvocationHandler object is set using 404 of FIG. 4 such that the ThreadBeanContainer can participate in the middle of a message process. The ContainerInvocationHandler is a handler object for allowing the method (on Message( ) in FIG. 4), which is defined in the listener interface such as 403 of FIG. 4, to be intercepted at a middle time to be transmitted to the container, allowing the container to receive this message such that the work such as a security check, a transaction check or an access history process is performed, and allowing the on Message( ) (207 of FIG. 2) of the corresponding ThreadBean finally prepared by the developer to be called. The ContainerInvocationHandler can be differentiated whenever the application server is implemented.

In step 708, the generated listener implementation object is returned.

In step 709, the listener implementation code returned from the run( ) of the ThreadBean is used to monitor the destination of the message such as 206 of FIG. 2.

In step 710, the message is transmitted from respective message sources.

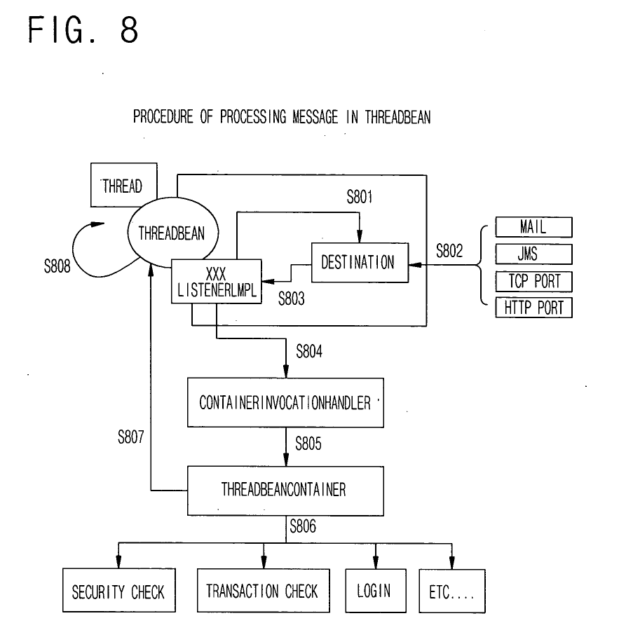

After the message destination is monitored through the above procedure, if the message is transmitted, the message is processed through a procedure of FIG. 8.

In step 801, the listener object allocated from the ListenerFactory monitors the message destination.

In step 802, an external message source sends the message.

In step 803, the message is transmitted to the listener implementation object.

In step 804, the message implementation object transmits a corresponding message to its own ContainerInvocationHandler object. Since the listener defined by a user can have one or more of the methods, the ContainerInvocationHandler is called using the method object and parameter as in FIG. 4.

In step 805, the ContainerInvocationHandler transmits the message to the ThreadBeanContainer.

In step 806, the ThreadBeanContainer performs the work such as the security check, the transaction check or login so as to process the transmitted message.

In step 807, the method of the ThreadBean object finally deployed by the developer is called.

In step 808, the corresponding method performs the business logic intended by the developer.

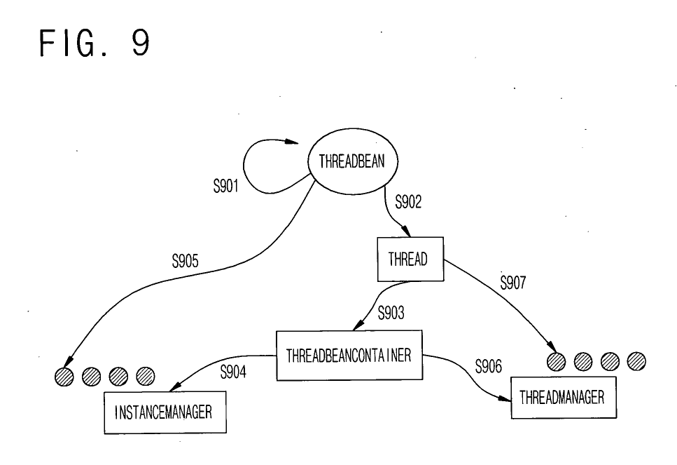

FIG. 9 illustrates a procedure where the work is ended or the container stops the execution of the ThreadBean in an abnormal operation.

In step 901, the stop( ) is called in the run( ) of the ThreadBean, or the ThreadBeanContainer calls the stop( ) of the ThreadBean for the purpose of management.

In step 902, the thread executing the ThreadBean senses a stop( ) method call.

In step 903, the ThreadBeanContainer is requested to end the use of the ThreadBean.

In step 904, the ThreadBeanContainer returns the corresponding used ThreadBean to InstanceManager possessed by the application server.

In step 905, the InstanceManager calls an ejbRemove( ) method of a use-completed ThreadBean instance to initialize internal variables and then, puts the method in a pool for reuse.

In step 906, the ThreadBeanContainer returns the thread, which is in charge of ThreadBean execution, to the ThreadManager.

In step 907, the ThreadManager performs the internal initialization procedure for the returned thread and then, puts the thread in the pool for reuse.

As described above, in the description and implementation method in the EJB container according to the present invention, the new type of EJB for receiving the allocated thread to perform the specific work is prepared to process the business logic needing the independent thread, that is, a socket or Java Message Service, a message entering a specific mail account, or an application periodically driven to perform a specific work such as a file backup, a statistic process or the like can be added to extend a process function of the EJB.

Further, various functions provided by the container, that is security management, transaction management, instance life period management and the like, can be applied to the newly proposed ThreadBean in the same way for use.

Furthermore, a detailed context monitored or worked by the ThreadBean is prepared by the Bean developer, the container manages only the thread and the life period of the ThreadBean, and all information necessary for a design of the ThreadBean are specified in the deployment descriptor, thereby providing pluggability for designing and plugging various types of work independently of the container.

It will be apparent to those skilled in the art that various modifications and variations can be made in the present invention. Thus, it is intended that the present invention covers the modifications and variations of this invention provided they come within the scope of the appended claims and their equivalents.

1. A description and implementation method of ThreadBean in an EJB (Enterprise Java Bean) container,
wherein the ThreadBean is defined using EJB to which independent thread is allocated such that looping is performed while a message entering a determined message target is processed or a business logic periodically driven to perform a specific work is processed.
